(19) United States
(12) Patent Application Publication
(10) Pub. No.: US 2010/0213198 A1
(43) Pub. Date: Aug. 26, 2010

(54) COMPOSITE STRUCTURE VESSEL AND TRANSPORTATION SYSTEM FOR LIQUEFIED GASES

(75) Inventors: Richard BROWN, Calgary (CA); Ronald Chad PORTER, Red Deer (CA); Brian Eugene SPENCER, Sacramento, CA (US); Daniel Guy POMERLEAU, Calgary (CA); Zachary B. SPENCER, Sacramento, CA (US)

Correspondence Address: OSLER, HOSKIN & HARCOURT LLP (OTHER), 1000 DE LA GAUCHETIERE STREET WEST, SUITE 2100, MONTREAL, QC, H3B-4W5, CA

(73) Assignee: FERUS INC., Calgary (CA)

(21) Appl. No.: 12/777,759

(22) Filed: May 11, 2010

Related U.S. Application Data
(63) Continuation of application No. PCT/US2009/041106, filed on Apr. 20, 2009.
(60) Provisional application No. 61/046,017, filed on Apr. 18, 2008.

(51) Int. Cl. F17C 13/00; F17C 1/12

(52) U.S. Cl. 220/560.08; 220/560.12

(57) ABSTRACT

The invention relates to a composite structure vessel and transportation system for liquefied gases and methods of manufacture. More specifically, the system provides a composite vessel for operative connection to a truck trailer system for transporting at least two gas products such as carbon dioxide and liquid nitrogen within the composite vessel at different times. The composite vessel includes an inner liner, a composite layer including a plurality of resin-impregnated fiber layers, a thermal insulation layer, and an outer protective layer.

### CROSS-REFERENCE

The present application is a continuation of PCT Application No. PCT/US2009/041106 filed on Apr. 20, 2009. Through the '106 application, this application claims priority to U.S. Provisional Application No. 61/046,017 filed on Apr. 18, 2008 and to U.S. patent application Ser. No. 12/425,982 filed on Apr. 4, 2009, the entirety of which are incorporated herein by reference.

### FIELD OF THE INVENTION

The invention relates to a composite structure vessel and transportation system for liquefied gases.

### BACKGROUND OF THE INVENTION

The use of liquid carbon dioxide (CO₂) and liquid nitrogen (N₂) in the natural gas and oil industries has been widespread over the last ten years.

In the natural gas industry, as natural gas drilling activity has increased as a result of increased market demand for natural gas and the extraction of natural gas becoming more marginal in terms of initial productivity and decline rates from gas wells, so has the requirement to stimulate (i.e., fracture) wells to maximize production. Liquid CO₂ is a prominent fluid used in well fracturing procedures within natural gas wells.

In addition, within the oil industry, CO₂ injection is the most commonly used enhanced oil recovery (EOR) technique. In this technique, CO₂ is injected into an oil reservoir to expand and thereby push additional oil to a production wellbore and/or it is used to dissolve in the oil to lower its viscosity and enhance the movement of the oil to a wellbore.

Liquid nitrogen is primarily used in Coal Bed Methane (CBM) applications. In this technique, N₂ is injected at high rates into a CBM well. The pressure build-up eventually causes fracturing mechanics to occur (i.e. causes seams in the rock formation to expand) opening channels for methane to flow to the wellbore for capture.

In each of the above, the liquefied carbon dioxide and nitrogen gases are manufactured at specialized cryogenic plants. These cryogenic plants are ideally, strategically located across an area such that they are located as close as possible to the customers and are built at locations based on the actual or anticipated demand for the liquefied gases such that the transportation costs for the gases between the well site and gas plant can be optimized. Clearly however, as a result of the operating efficiencies and capital costs of building cryogenic facilities together with long-term shifts in demand for product, the end-result is that significant volumes of liquefied gases will be transported significant distances between a cryogenic plant and a specific well site. Moreover, at present, liquefied gases are transported to a specific well site using specialized trailers with tankers designed to withstand the temperatures and pressures of a specific cryogenic cargo.

Specifically, and in the case of a tanker for liquid carbon dioxide, it is typical to use a tanker that can safely contain the liquefied product at approximately 300 psi and a temperature of −50° C. whereas in the case of a tanker for transporting liquid nitrogen, it is typical to use a tanker that can safely contain the liquid nitrogen at atmospheric to 50 psi pressure and −170° C.

A typical liquid carbon dioxide tanker usually has an insulated carbon steel structure whereas a liquid nitrogen tanker usually has a vacuum-sealed dual-wall stainless steel structure. Both tankers may incorporate insulation on the inner surfaces to limit heat gain from the exterior of the vessel. In the case of liquid nitrogen, insulation is of particular importance.

The total trailer weight (trailer plus payload) and the dimensions of heavy vehicles used in infra- and inter-provincial/state transportation are subject to strict federal and provincial/state standards. For example, in the province of Alberta, Canada, maximum legal weights for a Tridem Drive Truck—Tridem Semi Trailer are shown in Table 1. The normal maximum total weight of cargo and tanker permitted in the United States is typically about 35,000 kg.

More specifically, the general structure and payload capacities of currently used tankers for liquid carbon dioxide and liquid nitrogen transportation are as shown in Tables 2 and 3, respectively.

TABLE 1
Liquid Carbon Dioxide Tanker

| | |
|---|---|
| Vessel Construction | Insulated carbon steel |
| Vessel Capacity | 31,272 kg |
| CO₂Payload | 28,000 kg maximum (while |
| | transporting) |
| Pressure | 300 psi |
| Temperature | −50° F. |
| Empty Trailer Weight | 12,088 kg |

TABLE 2
Liquid Nitrogen Tanker

| | |
|---|---|
| Vessel Construction | Vacuum sealed stainless steel (dual wall) |
| Vessel Capacity | 31,544 kg |
| N₂ Payload | 28,000 kg maximum (while transporting) |
| Pressure | 50 psi |
| Temperature | −325° F. |
| Empty Trailer Weight | 10,646 kg |

In the past, the different conditions required to maintain CO₂ and N₂ in liquid phase (CO₂=high pressure and warmer temperature versus N₂=low pressure and cold temperature) has resulted in the construction of unique trailers/tankers for each product.

However, the use of unique trailers for each type of product will often result in poor or inefficient utilization of a company's resources when both products are being sold by the company. In certain circumstances, the physical locations of cryogenic plants may cause one tanker type to be driven significant distances without a cargo and/or during a period of reduced industry activity, a fleet of specialized tankers may be inactive. For example, when CBM activity is reduced as a result of lower gas prices, a liquid nitrogen tanker may see lower utilization.

Other problems with existing systems are discussed below:

The useful life of a typical steel vessel tanker/trailer is approximately fifteen years. Over that time, steel vessels will require preventive maintenance and/or repair and patch work as a result of rust and corrosion. As part of a preventive maintenance program, mort operators at a minimum will require at least three re-painting overhauls over the life of one N₂ trailer which is both expensive and time consuming. Further still, an operator having multiple trailer designs will also require specialized mechanics with the knowledge and capability to handle separate repair techniques and tools for each type of trailer.

Accordingly, as a result of the foregoing problems, there has been a need for a tanker/trailer system and method of operation that is capable of transporting different gas/liquefied gas cargoes within the same vessel to provide enhanced operational efficiencies in the geographical delivery of gas/liquefied cargoes between gas plants and consumers. More specifically, there has been a need for a cryogenic gas/liquid transportation system capable of transporting both liquid carbon dioxide and liquid nitrogen within the same vessel at different times.

A review of the prior art indicates that such a system and method has not been previously described. For example, U.S. Pat. No. 5,419,139, U.S. Pat. No. 6,047,747, U.S. Pat. No. 6,708,502, U.S. Pat. No. 7,147,124, U.S. Pat. No. 6,460,721 U.S. Pat. No. 3,163,313 each describes various vessel structures for transporting single gases/liquid gases. U.S. Pat. No. 1,835,699, U.S. Pat. No. 3,147,877, U.S. Pat. No. 3,325,037, U.S. Pat. No. 3,406,857 and U.S. Pat. No. 7,024,868 describe various pressure vessels. U.S. Pat. No. 5,385,263 describes a transportation system for compressed gas using composite cylinders.

### SUMMARY OF THE INVENTION

In accordance with the invention, there is provided a composite vessel for operative connection to a truck trailer system for transporting at least two gas products within the composite vessel at different times, the composite vessel comprising: an inner liner for contacting a gas product within the composite vessel; a composite layer operatively connected to the inner liner, the composite layer including a plurality of resin-impregnated fiber layers wound to provide pressure and structural integrity to the composite vessel while transporting each gas product; a thermal insulation layer operatively bonded to the exterior of the composite layer for providing a thermal barrier between the interior and exterior of the composite vessel; and, an outer protective layer operatively bonded to the thermal insulation layer for providing abrasion and impact resistance to the thermal insulation layer during truck movement.

In further embodiments, collectively each of the inner liner, composite layer and thermal insulation layer have a heat transfer coefficient that minimizes atmospheric gas loss to less than 2% of the total volume of gas product from the composite vessel over a 24 hour time period at ambient temperatures.

In a preferred embodiment, the composite vessel is cylindrical having isotensoid geodesic ends. Each isotensoid geodesic end will preferably include a penetration extending from the exterior to the interior of the vessel with each penetration supporting a boss and a seal ring operatively connected to the composite vessel between the inner liner and composite layer adjacent the penetration.

In further embodiments, the composite layer includes a plurality of alternating helical and hoop wound layers. In various embodiments, the helical layers are wound at an angle of ±15-25° to the longitudinal axis of the vessel and the hoop layers are wound at ±80-90° to the longitudinal axis of the vessel.

In another aspect of the invention, the invention provides a method of manufacturing a composite vessel having an inner liner, composite layer, insulating layer and protective layer, the composite vessel for operative connection to a truck trailer system for transporting at least two gas products within the composite vessel at different times, comprising the steps of: assembling the inner liner and two pairs of a boss and a seal ring on a supporting axle; rotating the assembled liner about a longitudinal axis of the supporting axle and applying layers of resin-impregnated fiber over the liner at series of desired angles to form a composite vessel; allowing the composite vessel to cure; applying the insulating layer to the exterior of the vessel; and, assembling the protective layer onto the exterior of the insulating layer.

In yet another embodiment, the invention provides a tanker trailer comprising: a tridem trailer; a composite vessel for operative connection to the tridem trailer, the composite vessel for transporting at least two gas products within the composite vessel at different times, the composite vessel having: an inner liner for contacting a gas product within the composite vessel; a composite layer operatively bonded to the inner liner, the composite layer including a plurality of resin-impregnated fiber layers wound to provide pressure and structural integrity to the composite vessel while transporting each gas product; a thermal insulation layer operatively bonded to the exterior of the composite layer for providing a thermal barrier between the interior and exterior of the composite vessel; and, an outer protective layer operatively bonded to the thermal insulation layer for providing abrasion and impact resistance to the thermal insulation layer during truck movement.

### BRIEF DESCRIPTION OF THE DRAWINGS

The invention is described by the following detailed description and drawings wherein:

FIG. 1 is a cross-sectional drawing of a composite tank in accordance with one embodiment of the invention showing detail of a boss and sealing system.

### DETAILED DESCRIPTION

In accordance with the invention and with reference to the FIGURE, embodiments of a tanker having a composite structure for transporting cryogenic liquids are described.

In its broadest sense, a composite structure is described for transporting different cryogenic liquids within the same vessel at different times. In more specific embodiments, a composite structure system is described for storing and transporting both liquefied carbon dioxide and nitrogen. The composite structure results in a significant weight reduction in the empty weight of tanker system thus enabling approximately 20% more cargo to be transported by a single tanker.

Structure

The structure of the composite vessel in accordance with the invention is comprised of various layers of material as outlined in Table 3.

TABLE 3
Composite Vessel Structure

| | Thickness | | |
|---|---|---|---|
| Layer | (nominal) | Description | Function |
| Outer | 2 mm | Thermal spray coating Clear | Wear and corrosion protection, |
| Protective | | Coat ™, composite, or metal | concealment, very low weight |
| Layer | | | |
| Insulation | 120 mm | Polyurethane foam (2-2.5 lb. | Thermal barrier, impact |
| | | density) | protection |
| Composite | 6 mm | Carbon-fiber or Fiber-glass | Pressure strength, thermal |
| Shell | | reinforcement | barrier |
| Inner Liner | 6 mm | Polymeric material (e.g., | Payload contaminant barrier, |
| | | polyethylene, epoxy, | thermal barrier |
| | | dicyclopentadiene, urethane) | |

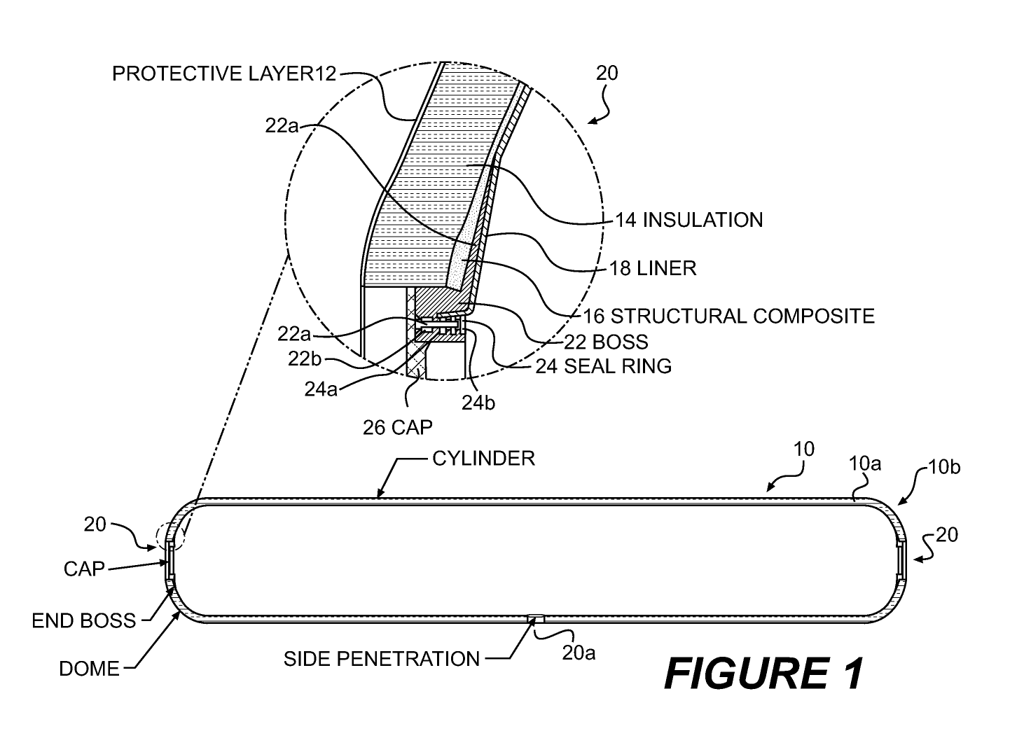

More specifically and as shown in FIG. 1, the system 10 includes an outer protective layer 12, an insulation layer 14, a structural composite layer 16 and inner liner 18. The composite vessel will also include at least two bosses 20, one of which will be permanently sealed according to safety regulations, the other for accessing the interior from either end of the vessel. Each of these layers are described in greater detail below:

Outer Protective Layer 12

The outer protective layer provides wear and corrosion protection to the underlying structures. The outer protective layer has a nominal thickness of 2-3 mm and may be a thin metal layer such as stainless steel or a composite material such as fiberglass. In addition to protection this layer may also assist in concealing the cargo. It is preferred that the outer protective layer is light weight in order to not substantially contribute to the overall weight of the vessel and cargo.

Insulation Layer 14

The insulation layer is the primary thermal barrier between the exterior and interior of the vessel. The insulation layer has a nominal thickness of 120 mm. A preferred insulating material is polyurethane foam (2-2.5 lb density) spray coated to the underlying composite layer. In addition, the insulation layer will also provide impact protection to the main structural composite layer 16.

Composite Structural Layer 16

The composite structural layer 16 is the main structural layer of the vessel and is comprised of composite layers of carbon-fiber and/or fiber-glass within a resin matrix. Other fibers may also be used, such as basalt, polyethylene, Kevlar, etc. as known to those skilled in the art. For most systems, the composite layer will have a nominal thickness of 6-8 mm. The composite layer is preferably comprised of sub-layers of resin-impregnated fibers wound at varying orientations to provide multi-axis structural strength to the vessel including burst, torque and bending strength. For example, circumferentially (or hoop) wrapped fibers are used to provide structural strength in a radial direction with respect to the vessel's horizontal/longitudinal axis (i.e. burst strength) whereas longitudinally or helically wrapped fibers (or fibers wrapped at smaller angles relative to the vessel's horizontal/longitudinal axis) generally provide strength along a transverse axis of the vessel. The combination of the two layers provides bending/torque strength. The composite layer also provides an additional thermal barrier to the interior of the vessel.

More specifically, in one embodiment, the composite structural layer will be carbon fiber consisting of distinct layers of wound fiber that are wound at different angles (both positive and negative angles) to the horizontal axis of the vessel. In order to promote maximum strength between adjacent layers, successive layers of both helically and circumferentially wrapped layers are alternated. For example, a first layer may comprise two winds of helically wound carbon fiber, wound at an angle of approximately 15-25 degrees to the horizontal axis. The wind angle will generally be determined during design of a specific tank using known mathematical modelling techniques that seek to minimize void space and resin volume within a composite matrix while maximizing the fiber volume ratio for a given boss diameter and end radius (i.e. a geodesic isotensoid dome described in greater detail below) without gaps or overlap in the composite structure. For example, for a given ratio of boss diameter to dome end radius, 18.7 degrees may be a preferred wind angle at both positive and negative wind angles. A larger ratio would generally require a larger wind angle. A second layer may comprise circumferentially wound carbon fiber, wound at an angle between 80 and 90 degrees to the horizontal axis (wound at both positive and negative wind angles). Each of the first and second layers may then be alternated as desired or in accordance with another sequence to form a vessel having a desired hoop:helical stress ratio. In a preferred embodiment, the vessel will comprise approximately 18 hoop layers interspersed with 6 helical layers resulting in a total nominal thickness of approximately 5-8 mm.

Liner 18

The inner liner layer provides both payload contaminant protection and an additional thermal barrier to the interior of the vessel. The inner liner layer has a nominal thickness of 6 mm and may be comprised of a suitable polymeric material such as a polyethylene, epoxy, dicyclopentadiene and/or urethane having a low porosity. Stainless steel can also be used as a liner.

In the case of a thermoplastic liner, the liner may be manufactured by roto-molding as a single component or as multiple components and welded together.

The composite vessel will also preferably include internal baffles to minimize product shifting (sloshing) during transport. In a preferred embodiment, the baffles (not shown) are polyethylene baffles welded to the vessel liner after assembly of the vessel.

Boss 20

In a preferred embodiment, a boss 20 is located at each end of the vessel. One or more additional bosses 20a may also be located at other locations where penetrations through the cylindrical wall of the vessel are desired or necessary.

In a preferred embodiment, the vessel 10 has both a cylindrical mid-section 10a and geodesic isotensoid dome ends 10a. As such, there are three main functions of the end bosses.

The first is to provide a finite radius polar fitting at the terminus of the geodesic isotensoid dome. The radius of each polar end boss will depend on the diameter of the tank and the helical wind angle used in the filament winding process.

The second function of the end boss is to transmit forces acting on the boss and cap 26 from the pressurized fluid inside the tank to the vessel structures. That is, these loads are transmitted via a radial flange 22a that is contoured to match the geodesic dome contour.

The third function of the end boss is to provide a port for instrumentation, maintenance of internal components, or any other purpose.

The function of any additional bosses penetrating the cylindrical wall will vary depending on the purpose of the opening. Typical purposes include fluid inlets or outlets, instrumentation ports, or inspection ports, for example. The size and shape of these bosses will depend on their function and location on the tank, as well as tank geometry and other factors. Each boss may be fabricated from metal, polymer, ceramic, glass, composite or other materials as known to those skilled in the art.

As shown, both the boss 22 and composite layer 16 will include appropriate tapers in order to maximize the strength at boss/composite interface. Maximum thickness of both the composite layer and boss will be incorporated closest the opening in order to maximize strength of the vessel adjacent to and around the opening. That is, the composite layer will taper to the nominal composite layer thickness away from the opening and, similarly, the boss will also taper from a greater thickness adjacent the opening to a narrow end away from the opening.

Cap 26

Each boss where fluid inlet or outlet plumbing will not be attached will require a cap 26 that may be configured for other purposes. For example, an instrumentation port will be sealed with a cap that has features necessary for attachment of a particular transducer and for transmission of the transducer's signal from the inside of the tank to the outside.

The cap, like the boss, can be made from virtually any solid material. In a preferred embodiment, the caps will be made from compression molded carbon fiber composite with a hydro-formed liner of stainless steel or aluminium. As composite material can be porous, a metal lining will prevent fluid from seeping into the composite, potentially causing the composite material to swell or the microstructure to weaken.

The cap will interface and seal with the boss using an appropriate lock and seal system.

Seal Ring 24

The vessel includes a seal ring 24 to prevent fluid from flowing between the tank liner and a particular boss. The seal ring may be manufactured from any suitable material including stainless steel and includes a cylindrical bore 24b and a conical outer surface concentric with the bore that interfaces with a matching conical surface on the tank liner. The seal ring is secured within the boss 22 by an array of fasteners 22a that pass through the boss 22 to engage with the cylindrical bore 24b. The fastener 22a causes a series of redundant lip seals, glands, or ridges 24a to tighten against both the liner 18 and boss 22 to prevent fluid from flowing between the seal ring and the liner 18 and boss 22 at the conical interface. As a result, pressurized fluid is prevented from entering the region where the boss meets the tank liner.

The conical wedge seal ring design is intended to allow the pressurized fluid inside the tank to activate the sealing mechanism. Pressure acting on the exposed face of the seal ring forces the seal ring deeper into the conical pocket where it seals against the liner and boss. In addition, the conical wedge seal ring design provides a mechanism for compensating for any creep, a phenomenon characteristic of polymers that may be used for the liner.

As a result, this design allows for a simplification of maintenance procedures wherein, for example, service personnel will adjust the tension in the fastener 22a to pull the seal ring into the pocket. In another embodiment, the fastener 22a may be provided with a tensioning system that provides a constant force on the seal ring throughout its expected range of movement during the design service life of the tank. For example, helical coil springs 22b might be installed beneath a fastener screw head that are tightened in order to pull the seal ring into the pocket. The coil springs 22b would then provide a constant tension in the fasteners to compensate for any polymer tank liner material creep at the seal interface such that as any creep occurs, the seal ring will move deeper into the pocket.

Manufacture

In one embodiment, the vessel is manufactured in accordance with the following process:
a. The inner liner is manufactured and assembled to form a rigid/semi-rigid structure. As noted, the inner liner may be manufactured as a single component by roto-molding or assembled from smaller extruded/molded components.
b. The inner liner is assembled onto a supporting axle together with the bosses and seal ring. That is, preferably the end bosses, seal ring and liner are assembled onto a central supporting axle wherein the bosses, seal rings and liner are secured together. If necessary, the inner liner once assembled on the supporting axle may be moderately pressurized in order to increase the rigidity of the structure for winding.
c. The supporting axle is rotated and appropriate layers of resin-impregnated fiber are laid down over the liner at the desired angles.
d. The vessel is allowed to cure for an appropriate time period based on the resin-system utilized. It should be noted that the selection of the resin-system must consider a cure time and associated thermal characteristics to ensure that a thermoplastic liner is not damaged during curing.
e. After curing, the insulation layer and outer protective layer are assembled on the cured vessel.
f. The supporting axle is removed and any finishing is completed including the assembly of anti-slosh baffles within the vessel.

Composite Vessel Parameters

The required operating range for the parameters of pressure and temperature for the composite vessel to safely contain both a liquid carbon dioxide and liquid nitrogen cargo are outlined in Table 4.

TABLE 4
Composite Vessel Parameters

| Parameter | Range |
|---|---|
| Pressure | 0-350 psi |
| Temperature | 60° C. to −200° C. |

Other features/specification of the composite vessel and tanker/trailer system are detailed in Table 5.

TABLE 5
Composite Vessel/Tanker/Trailer Specifications

| Element/Parameter | Function/Value | |
|---|---|---|
| Liquid level indicator/ | accurately indicate the amount of liquid in | ±1% |
| measurement system | the composite vessel | |
| Pressure indicator/regulator/ | accurately indicate and regulate the | ±1% |
| measurement system | pressure of the fluid in the composite | |
| | vessel | |

| | |
|---|---|
| Valve and piping system | facilitate loading and unloading of the composite vessel |
| | using a single pump to reduce weight. |
| Controllable, variable output | allows fluid to be pumped out of the composite vessel at a |
| flow rate system | controllable rate. |
| Appropriate shields/enclosures | protect the pump, valves and piping from potential impacts |
| | from rocks or debris or in the event of a collision |
| Maximum product loss rate | 1% per 24 hour period |
| resulting from heat | |
| transfer/pressure relief | |
| Tank ambient temperature | +50° C. to −50° C. |
| range. | |
| Maximum allowable working | 200 psi (pressure test to 1000 psi) |
| pressure (MAWP): | |
| Primary relief pressure | 320 psi |
| Secondary relief pressure | 355 psi |
| Minimum pump flow rate | 1.51 m3/min |
| Minimum tank payload | 34,000 kg |
| Maximum tank length | 14.17 m |
| Maximum tank width | 2.44 m |
| Man-way diameter | 51 cm |
| Minimum design service life | 25 years |
| Temperature range for liquid | −210° C. < T < −196° C. |
| nitrogen | |
| Temperature range for liquid | −50.0° C. < T < −40.0° C. |
| carbondioxide | |
| Maximum wheelbase (kingpin | 10.95 m |
| to center rear triple-axle | |
| centerline) | |
| Maximum frontal overhang | 1.46 m |
| (kingpin to front of tank): | |
| Maximum rear overhang | 35% of wheelbase = 3.83 m |
| (center rear triple-axle | |
| centerline to rear of taller): | |
| Axle spacing | 1.52 m |
| Kingpin Joad | 45% of sprung taller weight (including payload) |
| Trailer axle set Joad | 55% of sprung trailer weight (18.33% per axle, for triple |
| | axle configuration) |
| Maximum combined weight of | 43,500 kg |
| trailer and payload | |
| Maximum impact load at tank | 2.5 g impact load |
| centerline (directed vertically | |
| upward; load applied directly | |
| to pump/piping protective | |
| housing or trailer frame; blunt | |
| object assumed to provide | |
| impact force. | |
| Maximum height of trailer | 3.35 m |
| (measured from ground level | |
| to highest part of tank or | |
| trailer) | |
| Inlet pipe diameter | 6″ |
| Outlet pipe diameter | 6″ |
| Vapor relief pipe diameter | 2″ |

In addition the tanker/trailer system will also incorporate compartments for housing appropriate hoses/tools typically required for connecting the fluid delivery (pump and piping) systems to external equipment as appropriate valve, piping and openings connected to or as part of the vessel.

Further still, the system will generally meet the appropriate US and Canadian codes to operate on Canadian and US highways as understood by those skilled in the art. While there are no specific regulations governing the design criteria for such a tanker/trailer system, it is understood that the system will be designed to comply with the primary integrity, safety and testing criteria as required by US and Canadian regulations. Specifically, it is intended that the tank design and test procedures for the integrity of the tank will comply with Canadian Standards Association B620-03 (Highway Tanks and Portable Tanks for the Transportation of Dangerous Goods), applicable sections of Code of Federal Regulations (CFR) Title 49 and ASME code Section 10 which are incorporated herein by reference.

Advantages

The composite vessel as described herein provides the following advantages over part systems.
an increased volumetric capacity (payload) of the trailer system;
reduced weight of the tank, trailer and plumbing components.

In addition, the system provides economic advantages over conventional tanker systems. Primarily, by enabling an approximate 20% increase in cargo capacity for a given total maximum weight of a loaded tanker and trailer, a liquefied product supplier can effectively deliver 20% more cargo for an equivalent shipping colt.

Further still, when a shipper is obtaining product from a number of geographically distributed gas plants, the ability of the current design to accommodate different cargoes may be used to optimize the deployment of a fleet of tankers to different gas plants and customers. That is, based on customer demand, customer location, and gas plant location, a common fleet of tankers may be deployed to ensure that each tanker is traveling a minimum distance between a customer and gas plant based on current demand. Importantly, if tankers do not necessarily have to return to a specific type of gas plant, the distance a tanker may travel to obtain a new cargo may be minimized.

The systems and methods described herein may also be adapted for use in hauling of other industrial gases including oxygen for chemical and pharmaceutical manufacturers, hydrogen for fuel cells or rare gases such as krypton, neon or xenon for lighting, lasers, or medical imaging.

Although the present invention has been described and illustrated with respect to preferred embodiments and preferred uses thereof, it is not to be so limited since modifications and changes can be made therein which are within the full, intended scope of the invention.

1. A trailer vessel for transporting liquefied gasses, the vessel having a cylindrical side wall, isotensoid geodesic ends, and a longitudinal axis, the vessel comprising:
an inner liner for surrounding a liquefied gas to be transported within the vessel;
a composite material layer surrounding the inner liner and bonded thereto, the composite layer including a plurality of alternating helical and hoop sub-layers of resin-impregnated fibers, the fibers of the helical sub-layers being oriented at a helical sub-layer angle of between ±15-25° to the longitudinal axis of the vessel, the fibers of the hoop sub-layers being oriented at a hoop sub-layer angle of between ±80-90° to the longitudinal axis of the vessel, the composite layer material having sufficient strength such that the operating range of the vessel with respect to the liquefied gas to be transported therein is up to 350 psi and down to −200° C.

2. A trailer vessel for transporting liquefied gasses as recited in claim 1, wherein the composite layer material has sufficient strength such that the operating range of the vessel with respect to the liquefied gas to be transported therein is between 0 to 350 psi and 60° C. to −200° C.

3. A trailer vessel for transporting liquefied gasses as recited in claim 2, wherein the fibers of the helical sub-layers are wound at a helical sub-layer angle of between ±15-25° to the longitudinal axis of the vessel, and the fibers of the hoop sub-layers are wound at a hoop sub-layer angle of between ±80-90° to the longitudinal axis of the vessel.

4. A trailer vessel for transporting liquefied gasses as recited in claim 3, wherein the resin-impregnated fibers comprise carbon fibers.

5. A trailer vessel for transporting liquefied gasses as recited in claim 3, wherein the resin-impregnated fibers comprise fiberglass.

6. A trailer vessel for transporting liquefied gasses as recited in claim 3, wherein the thickness of composite material layer is between 5 to 8 mm.

7. A trailer vessel for transporting liquefied gasses as recited in claim 3, wherein the thickness of composite material layer is 6 mm.

8. A trailer vessel for transporting liquefied gasses as recited in claim 3, wherein the inner liner comprises a polymeric material.

9. A trailer vessel for transporting liquefied gasses as recited in claim 8, wherein the inner liner comprises one selected from a group consisting of low-porosity polyethylene, epoxy, dicyclopentadiene and urethane.

10. A trailer vessel for transporting liquefied gasses as recited in claim 8, further comprising baffles bonded to the inner liner.

11. A trailer vessel for transporting liquefied gasses as recited in claim 3, wherein the vessel includes a single opening permitting access to its interior.

12. A trailer vessel for transporting liquefied gasses as recited in claim 2, wherein the vessel includes a single opening permitting access to its interior.

13. A trailer vessel for transporting liquefied gasses as recited in claim 12, wherein the single opening of the vessel is located in the side wall of the vessel and generally faces the ground when the vessel is connected to a truck trailer.

14. A trailer vessel for transporting liquefied gasses as recited in claim 13, wherein the side wall of the vessel is reinforced in a vicinity of the single opening by thickening composite material layer.

15. A trailer vessel for transporting liquefied gasses as recited in claim 3, wherein each of the geodesic isotensoid dome ends includes a polar boss secured to the inner liner, each polar boss being at least partially covered by the composite material layer.

16. A trailer vessel for transporting liquefied gasses as recited in claim 2, further comprising:
a thermal insulation layer surrounding the composite material layer and bonded thereto;
and
an outer protective layer surrounding the thermal insulation layer and bonded thereto.

17. A trailer vessel for transporting liquefied gasses as recited in claim 3, further comprising:
a thermal insulation layer surrounding the composite material layer and bonded thereto;
and
an outer protective layer surrounding the thermal insulation layer and bonded thereto.

18. A trailer vessel for transporting liquefied gasses as recited in claim 3, wherein the vessel is capable of transporting liquefied carbon dioxide and nitrogen at different times without structural modification.

19. A trailer vessel for transporting liquefied gasses as recited in claim 2, wherein the vessel is capable of transporting liquefied carbon dioxide and nitrogen at different times without structural modification.

20. A trailer vessel for transporting liquefied gasses as recited in claim 2, wherein the vessel is capable of transporting liquefied carbon dioxide and nitrogen at different times without structural modification.
